(19) United States
(12) Patent Application Publication
(10) Pub. No.: US 2003/0010851 A1
(43) Pub. Date: Jan. 16, 2003

(54) Sprinkling nozzle having a pliable barrel

(75) Inventor: Chin-Yuan Chen, Chang-Hua Hsien (TW)

Correspondence Address: Harrison & Egbert, 412 Main St., 7th Floor, Houston, TX, 77002, US

(73) Assignee: Shin Tai Spurt Water of the Garden Tools Co., Ltd.

(21) Appl. No.: 09/903,908

(22) Filed: Jul. 13, 2001

(51) Int. Cl. B05B 15/08

(52) U.S. Cl. 239/588

(57) ABSTRACT

A sprinkling nozzle structure comprises a fixation body, a hose connecting body, a hand grip, a spout member, and a barrel member. The hose connecting body is fastened with one end of the fixation body. The fixation body is fastened at other end with the barrel member which is in turn fastened with the spout member. The barrel member is pliable to facilitate the directing of the spout member at a hard-to-reach area which is intended to be washed.

### BACKGROUND OF THE INVENTION

1. Field of the Invention

The present invention relates generally to a sprinkling system, and more particularly to a sprinkling nozzle having a pliable barrel to facilitate the directing of the nozzle.

2. Description of Related Art

The conventional sprinkling nozzle comprises a barrel and a spout which is fastened with one end of the barrel for discharging a liquid. The barrel is fastened at other end with a hose. The barrel is so rigid that it can not be bent to facilitate the spout to reach a hard-to-reach area, thereby subjecting the user of the conventional sprinkling nozzle to maneuver in various ways to reach the hard-to-reach area at the risk of injury.

### BRIEF SUMMARY OF THE INVENTION

The primary objective of the present invention is to provide a sprinkling nozzle which is free of the shortcoming of the conventional sprinkling nozzle described above.

The features, functions, and advantages of the present invention will be readily understood upon a thoughtful deliberation of the following detailed description of a preferred embodiment of the present invention with reference to the accompanying drawings.

### BRIEF DESCRIPTION OF THE SEVERAL VIEWS OF THE DRAWINGS

FIG. 1 shows a perspective view of the preferred embodiment of the present invention.

FIG. 2 shows an exploded view of the preferred embodiment of the present invention.

FIG. 3 shows a side schematic view of the preferred embodiment of the present invention.

FIG. 4 shows a side schematic view of the preferred embodiment of the present invention in action.

FIG. 5 shows a partial longitudinal sectional view of the preferred embodiment of the present invention as shown in FIG. 3.

FIG. 6 shows a partial longitudinal sectional view of the preferred embodiment of the present invention as shown in FIG. 4.

### DETAILED DESCRIPTION OF THE INVENTION

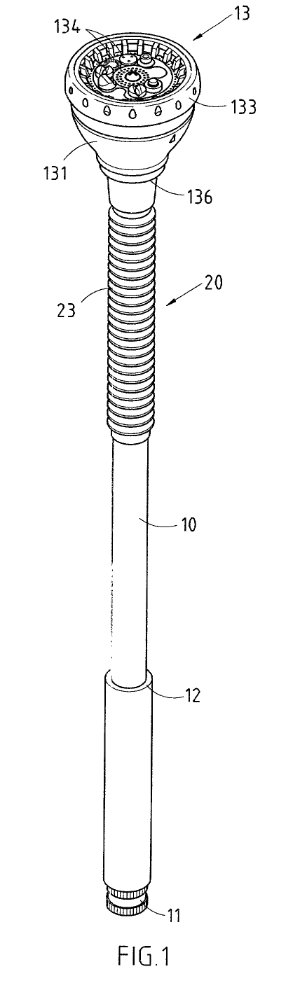

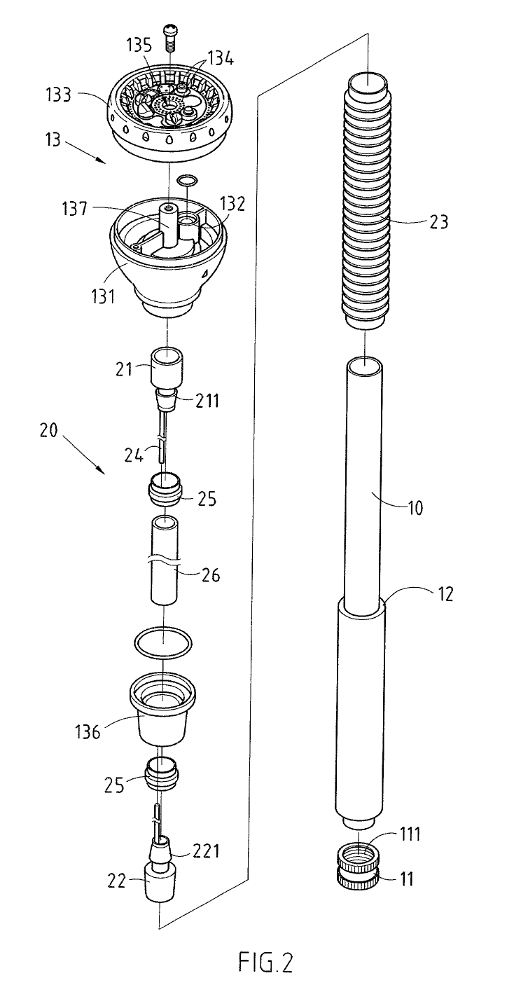

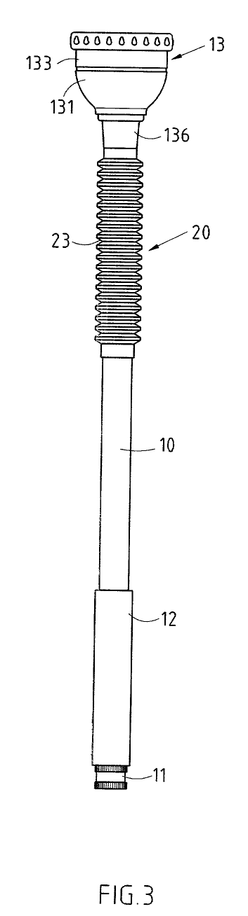

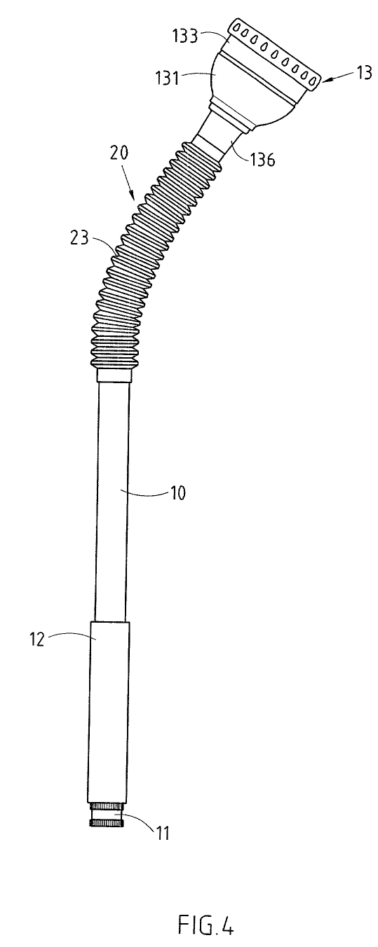

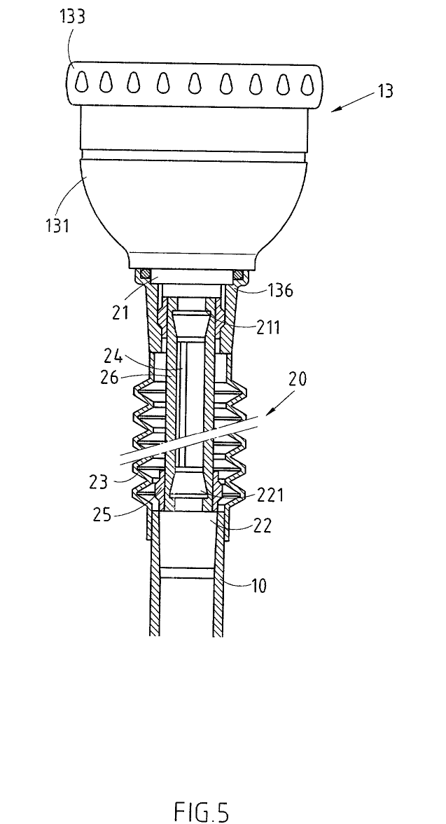

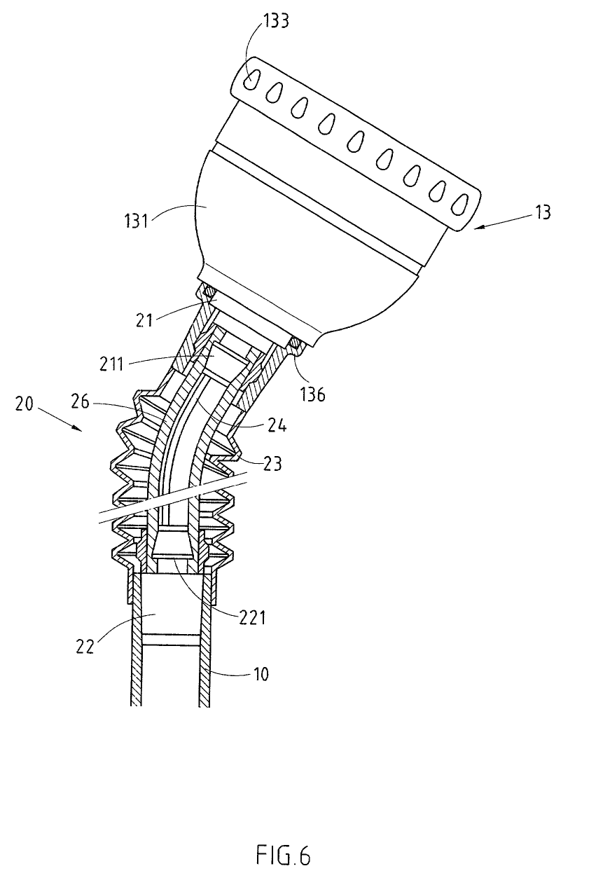

As shown in FIGS. 1-6, a sprinkling nozzle of the preferred embodiment of the present invention comprises a fixation body 10, a hose connecting body 11, a hand grip 12, a spout member 13, and a barrel member 20.

The fixation body 10 is fastened at one end with the hose connecting body 11, and at other end with the barrel member 20. The hand grip 12 is fitted over the fixation body 10. The hose connecting body 11 is provided at one end with inner threads 111 which are engaged with the one end of the fixation body 10. The hose connecting body 11 is connected at other end with a hose (not shown in the drawings).

The spout number 13 is formed of a bottom body 131 which is provided in the interior with a water guiding tube 132, a top body 133 which is provided with a plurality of water discharging holes 134 and a fastening hole 135, and a disposition member 136 fitted over the bottom of the bottom body 131.

The barrel member 20 is formed of an inner tube 21 having an inverted hooked structure 211, and a pliable metal body 24 which is fastened at other end with another inner tube 22 having an inverted hooked structure 221. An inner guide tube 26 is joined with the inverted hooked structures 211 and 221 in conjunction with an annular fitting member 25. A pliable outer tube 23 is fastened at one end with the fixation body 10 and at other end with the spout member 13.

The bottom body 131 and the top body 133 of the spout member 13 are joined together by a joining rod 137 which is received in the fastening hole 135 of the top body 133.

In light of the outer tube 23 and the metal body 24 being pliable, the barrel member 20 can be elastically deformed to allow the spout member 13 to be directed at a hard-to-reach area to facilitate the washing of the hard-to-reach area.

The preferred embodiment of the present invention described above is to be regarded in all respects as being illustrative and not restrictive. Accordingly, the present invention may be embodied in other specific forms without deviating from the spirit thereof. The present invention is therefore to be limited only by the scopes of the following claims.

I claim:

1. A sprinkling nozzle structure comprising:
a fixation body fastened at one end with a hose connecting body, and at other end with a barrel member, said fixation body provided with a hand grip fitted thereover, said hose connecting body provided at one end with a plurality of inner threads which are engaged with the one end of said fixation body, said hose connecting body being connected at other end with a hose;
a spout member formed of a bottom body which is provided in an interior with a water guiding tube, a top body which is provided with a plurality of water discharging holes and a fastening hole, said bottom body being provided with a disposition member fitted over a bottom of said bottom body; and
a barrel member formed of an inner tube having a first inverted hooked structure, and a pliable metal body which is fastened at other end with another inner tube having a second inverted hooked structure, said first inverted hooked structure and said second inverted hooked structure being joined with an inner guide tube in conjunction with an annular fitting member, a pliable outer tube being fastened at one end with said fixation body and at other end with said spout member.

2. The sprinkling nozzle structure as defined in claim 1, wherein said bottom body and said top body of said spout member are joined together by a joining rod which is received in said fastening hole of said top body.
